(19) United States
(12) Patent Application Publication
(10) Pub. No.: US 2012/0284341 A1
(43) Pub. Date: Nov. 8, 2012

(54) Controlling Virtual Social Networks

(75) Inventors: Syed Ghouse MASOOD, Kuala Lumpur (MY); Matti Ropponen, Espoo (FI); Sami Visti, Espoo (FI)

(73) Assignee: F-Secure Corporation

(21) Appl. No.: 13/101,636

(22) Filed: May 5, 2011

(51) Int. Cl. G06F 15/16

(52) U.S. Cl. 709/205

(57) ABSTRACT

An example embodiment of the present invention provides an apparatus including at least one processor; and at least one memory including executable instructions, the at least one memory and the executable instructions being configured to, in cooperation with the at least one processor, cause the apparatus to perform at least the following: retrieve from a social networking service at least one of: user profile information of a user and user profile information of each contact node of the user in the social networking service; and a connection structure between the user and each contact node of the user, analyze the retrieved user profile information and/or the determined connection structure, and separate any outliers among the contact nodes on the basis of the analysis.

### TECHNICAL FIELD

The exemplary and non-limiting embodiments of the present application relate generally to methods, apparatuses and computer programs and, more specifically, to the field of virtual social network services provided by electronic communication systems.

### BACKGROUND

The online social interaction between individuals that has been enabled by virtual social networks is one of the most important developments of this decade. Almost everyone who has access to the Internet is a member of a social network in some way. This applies to both adults and children, who use virtual social networks to communicate with friends, relatives and various other interest groups online.

Typical users of virtual social networks may have hundreds of friends in their social graph through different social network services, such as Facebook or MySpace. Social graph here refers to the mapping of a user's friends and how they are connected together in a social network. The social graph may describe the relationships between individuals online. The social graph of a user can be very dynamic, with new friends added and old ones removed quite often. There is also a risk that some of those friends may be undesirable and even potentially dangerous, for example, for an underaged user in the form of a potential predator, or for a computer system itself due to possible malware or phishing attacks. There is a continuous need to develop ways to control electronic communication systems that may provide virtual social network services.

### SUMMARY

The following presents a simplified summary of the invention and provides a basic understanding of some aspects of the invention. The summary is not an extensive overview of the invention, and does not identify key elements of the invention or specify the scope of the invention. Its sole purpose is to present some concepts of the invention in a simplified form as an introduction to the more detailed description that is presented later.

The claims describe various aspects of the invention.

According to one aspect of the present invention, there is provided a method, comprising: retrieving from a social networking service at least one of: user profile information of a user and user profile information of each contact node of the user in the social networking service; and a connection structure between the user and each contact node of the user, analyzing the retrieved user profile information and/or the retrieved connection structure, and separating any outliers among the contact nodes on the basis of the analysis.

According to a second aspect of the present invention, there is provided an apparatus, comprising: at least one processor; and at least one memory including executable instructions, the at least one memory and the executable instructions being configured to, in cooperation with the at least one processor, cause the apparatus to perform at least the following: retrieve from a social networking service at least one of: user profile information of a user and user profile information of each contact node of the user in the social networking service; and a connection structure between the user and each contact node of the user, analyze the retrieved user profile information and/or the retrieved connection structure, and separate any outliers among the contact nodes on the basis of the analysis.

According to a third aspect of the present invention, there is provided a computer program comprising a computer-readable medium bearing computer program code embodied therein for use with a computer, the computer program code comprising: code for retrieving from a social networking service at least one of: user profile information of a user and user profile information of each contact node of the user in the social networking service; and a connection structure between the user and each contact node of the user, code for analyzing the retrieved user profile information and/or the retrieved connection structure; and code for separating any outliers among the contact nodes on the basis of the analysis.

All combinations of the various aspects, embodiments and features of the invention are possible and within the scope of the present invention as claimed.

### BRIEF DESCRIPTION OF THE DRAWINGS

The accompanying drawings provide a more complete understanding of the embodiments of the present invention according to the following descriptions:

FIG. 1 shows a simplified block diagram that illustrates an example of apparatuses according to the invention;

FIG. 2 shows an example of a method;

FIG. 3 is an example of a use case scenario; and

FIG. 4 is another example of a use case scenario.

### DETAILED DESCRIPTION OF THE DRAWINGS

Example embodiments of the present invention are later described in more detail with reference to the accompanying drawings, in which some embodiments of the invention are shown. The invention may be embodied in many different forms and should not be construed as limited to the embodiments set forth here. Although the specification may refer to “an”, “one”, or “some” embodiment in several locations, this does not necessarily mean that each such reference is to the same embodiment, or that the feature only applies to a single embodiment. Single features of different embodiments may also be combined to provide other embodiments.

The present invention can apply to any terminal, server, corresponding component, or to any communication system or combination of different communications systems that support the required functionality. Due to the rapid development of the specifications of computer systems and protocols that are used, all words and expressions should be interpreted broadly; they are intended only to illustrate the embodiment.

The terms “social networking service” and “virtual social networks” as used herein may describe, for example, a virtual community service, an online service, platform or site focused on building and reflecting social networks or social relations among users. A social networking service may include a representation of each user in the form of a user profile, his/her social links and a variety of additional services, such as games. The social networking service may be web-based and may provide means for users to interact over the Internet. Examples of social networking services include Facebook, Twitter, Nexopia, Bebo, StudiVZ, Tuenti, Tagged, Skyrock, Friendster, LinkedIn, Cyworld and PlayStation Network.

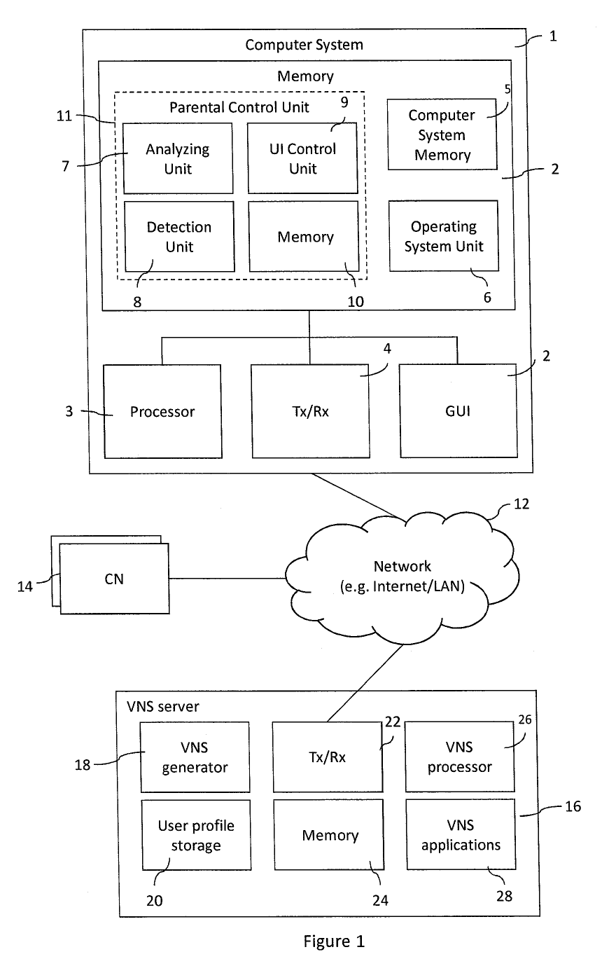

FIG. 1 illustrates a general example of apparatuses in which the embodiments of the invention may be applied. It only shows the elements and functional entities that are required for understanding the arrangement according to an embodiment of the invention. Other components have been omitted for the sake of simplicity. The implementation of the elements and functional entities may vary from that shown in FIG. 1. The connections shown in FIG. 1 are logical connections, and the actual physical connections may be different. It is apparent to a person skilled in the field that the arrangement may also comprise other functions and structures.

FIG. 1 is a schematic illustration of an example of a computer system 1 that is suitable for implementing the methods that are described below. The computer system 1 can be implemented as a combination of computer hardware and software. The computer system 1 comprises a memory 2, a processor 3 and a transceiver 4. The memory 2 stores the various programs or executable files that are implemented by the processor 3, and provides a computer system memory 5 that stores any data required by the computer system 1. The programs or executable files that are stored in the memory 2, and implemented by the processor 3, can include an operating system unit 6, an analyzing unit 7, a detection unit 8, and a user interface 9. The memory 2 also provides a memory 10 that is used by the detection unit 8 and the inventory unit 9. The analyzing unit 7, the detection unit 8, the user interface 9 and the memory 10 can be sub-units of a parental control application unit 11. The transceiver 4 is used to communicate over a network 12 such as a LAN or the Internet. Typically, the computer system 1 may be a personal computer (PC), laptop, personal data assistant (PDA) or mobile phone, or any other suitable device.

The computer system 1 may communicate over the network 12 with a virtual networking server (VNS server) 16. The VNS server 16 may comprise a transceiver 22, a memory 24, a VNS generator 18, storage for user profile information 20, a VNS processor 26 and VNS applications 28. The embodiments of the present invention may be realized in the form of computer program products such as applications used for parental monitoring purposes. It is possible that such computer program products are provided by the VNS server from a VNS application unit 28. It is also possible that such computer program products are provided from a security service provider or an operator server to the computer system 1 or to the VNS server 16.

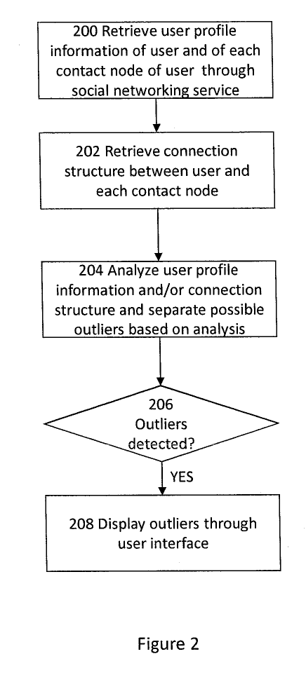

FIG. 2 is a flow diagram illustrating an example of a process. The method starts in 200 and 202 where at least one of the following: the user profile information of a user and the user profile information of each of the user's contact nodes 14 in the social networking service and/or a connection structure between the user and each contact node of the user is retrieved from a social networking service 16. The computer system 1 may communicate over the network 12 with the VNS server 16 in order to retrieve the user profile information and/or the connection structure. The user profile information of the user and of each of the user's contact nodes 14 and/or connection structure information may be stored in the user profile storage 20 of the VNS server 16. It is also possible that the user profile information has already been provided to the computer system 1 and stored in the memory 10. The user profile information of the user and the user's contact nodes 14 may be updated to the computer system 1 regularly or, for example, each time there are changes to the user profile information of the contact nodes. The detection unit 8 may process the retrieving of the user profile information.

In an embodiment, the connection structure between the user and each of the user's contact nodes may also be determined on the basis of the retrieved user profile information of the user and of each contact node of the user. This may be processed by the analyzing unit 7, for example. In another embodiment, the connection structure between the user and each of the user's contact nodes may be a separate entity that is not dependent on the user profile information.

In 204, the retrieved user profile information and/or the determined connection structure is analyzed in the analyzing unit 7 and any outliers among the contact nodes are separated on the basis of the analysis.

If outliers are detected in 206, then the process enters 208 where the outliers are displayed through a user interface 2 of the apparatus. The user interface control unit 9 may control the presentation of found outliers in the user interface 2.

In an embodiment, the user profile information retrieved in 200 may be a collection of personal data associated to a specific user. The user profile may refer to an explicit digital representation of a person's identity. The user profile may also be considered to be the computer representation of a user model. In an embodiment, the user profile information comprises one or more of the following data elements but not limited to: age, gender, school, hometown, country, list of friends, relationship, work-related information, specific interests, religion, political opinion, hobbies, favorite games, any available information from the user profile. The user profile can be used to store the description of the characteristics of a person. This information can be exploited by systems that take the person's characteristics and preferences into account. For instance, profiles can be used by adaptive hypermedia systems that personalize the human computer interaction.

In an embodiment, also other data sources can be used in addition to the user profile information retrieved from the social networking service for separating the outliers. In an embodiment, information can be retrieved from one or more data sources outside the social networking service; and the retrieved information from one or more data sources outside the social networking service may be used with the retrieved user profile information from the social networking service for separating the outliers. Thus, any information from one or more systems outside of the social networking service may be used and, for example, combined with the retrieved user profile information. This combined data may then be used in the analysis. Further, the combined data of the retrieved user profile information and data retrieved from any other data sources can be analyzed together with the connection structure in order to separate the possible outliers. An example of such a system outside of the social networking service is an email system of the user. Information from the email system may be combined with the user profile information from the social networking service. For example, the number of messages between two parties may be indicative for being an outlier or non-outlier. Other data sources from where different information for separating the outliers could be retrieved may comprise, for example, operating systems, computer programs, dynamic websites, recommender systems, mobile applications etc.

In an embodiment, determining the connection structure in 202 may comprise retrieving information relating to connections and interconnections between different contact nodes of the user in the social networking service and between the user and each contact node of the user.

In an embodiment, analyzing the retrieved user profile information and/or the determined connection structure in 204 may include comparing one or more data elements of the user profile information of the user and one or more corresponding data elements of the user profile information of each of the user's contact nodes. In an embodiment, possible outliers may be determined based on analysis of the connection structure only. In another embodiment, only user profile information is used in the analysis for separating the outliers. In another embodiment, both the connection structure and user profile information are used in the analysis for separating the possible outliers.

In an embodiment, analyzing the retrieved user profile information and the determined connection structure in 204 may further comprise using cluster analysis or corresponding detection techniques for separating the outliers. An outlier here may mean an outlying observation or an outlier that appears to deviate markedly from other members, in this case from other contact nodes, of the sample in which it occurs. Cluster analysis in this context may be an assignment of a set of observations into subsets (called clusters) where observations in the same cluster are similar in some sense.

In an embodiment, the separation of possible outliers in 204 may comprise predetermining one or more rules based on data elements of the user profile information and detecting whether the required data elements of the user profile information of a contact node fulfill the predetermined one or more rules in order to separate the outliers.

In an embodiment, the outlier separation results are presented through a user interface of the apparatus. The separation results may be, for example, displayed in a graphical user interface in the form of a visual map of a cluster.

In an embodiment, a social graph of a user may be determined based on the retrieved user profile information. The social graph may be created by mapping the contact nodes, such as friends included in a friend's list, and determining how they are connected in a social network. The social graph may describe the relationships between individuals online. The social graph may be a list of friends that has been created for the user by the social network service 16, such as the friend's list in Facebook.com service.

In an embodiment, the connection structure of the social graph of the user is determined, for example, using a cluster analysis, and the social graph is analyzed by using the profile information and connection structure determined earlier. The purpose of the analysis is to find possible outliers, for example, undesirable friends, among “normal contact nodes”. The “normal contact nodes” may be described as a natural group of friends in the social graph, for example. The natural group of friends may be defined as the members of a user's social graph who have a lot of things in common with the user. For example, they may go to the same school, be in the same age group, live in the same city, have several friends in common or countless other things.

In an embodiment, comparing specific attributes detected from user profile information and connection structures can be used for separating the outliers, in addition to generic outlier detection techniques. In the following use case example an example of patterns that can be used in the method are: if a child is aged 13 years old and the friend in the child's friend's list is aged 45, and the friend is not listed as a relation to the child, and the friend and the child do not have other friends in common, then this friend is determined to be an outlier and a potentially undesirable friend for the child. Based on this use case example, a set of rules can be determined on data elements of the user profile information and if the required data elements named in the predetermined rules of the user profile information of a contact node are not accepted based on the rules, then this contact node may be determined to be an outlier.

An example of a predetermined rule may be that the age difference between the user and a contact node is not allowed to be over 10 years unless they are related to each other. It is possible that the user of the application is offered to set the rules himself/herself via the user interface. It is also possible that there are a number of set rules that are automatically used or that can be selected from a list of rules or both. It is possible that the rules can be selected based on desired security levels, so that for an adult user, the rules may not be as strict as for a child.

Another example of a use case scenario that can be used for predetermining the rules may be: if a child is aged 13 years old and the friend is aged 14 years old, they share the same school, live in the same city and have 9 friends in common, then this friend belongs to the child's natural group of friends and is most likely safe. Thus, to be an accepted contact node of the user, certain data elements retrieved from the user profile of the contact node may be required to fulfill several conditions that may be predetermined in the form of one or more rules.

The potentially undesirable outliers and natural group of friends determined may be presented to the user, for example to a parent of a child, as a visual map of clusters for allowing easy examining of the results.

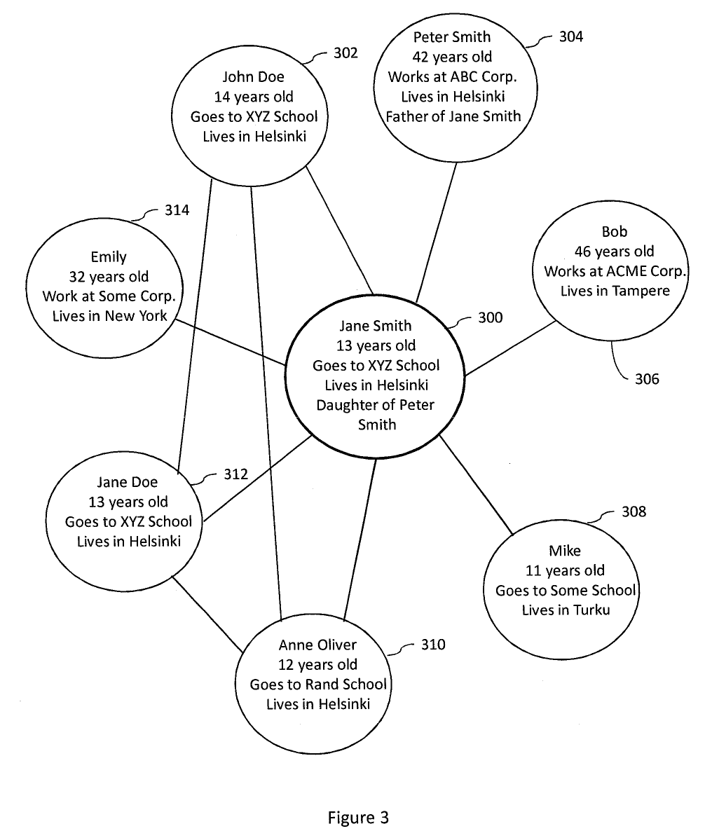

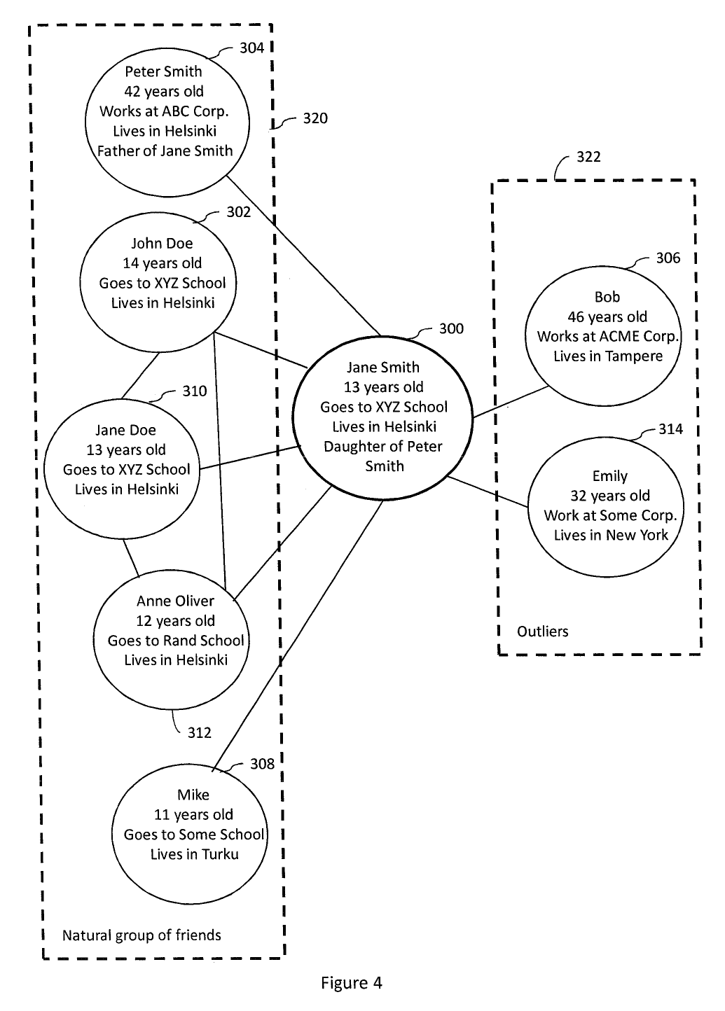

FIG. 3 illustrates a use case scenario of a social graph of a child 300 on a social network. Each contact node 302 to 314 of the child 300 includes numerous attributes in their user profiles. The lines between the contact nodes 302 to 314 and the child 300 describe friendship connections retrieved, for example, based on the friend's list information. As can be seen from FIG. 3, it is hard to see easily which friends are potentially undesirable without examining each one manually. For example, children typically may have hundreds of friends in their social graph on different social networking services. In order to separate the potentially undesirable friends, a parent may have the social graph of FIG. 3 analyzed by an example application of the invention, and be presented with a graphical overview of the results. An example of how the results of the analysis may be displayed in a graphical user interface is illustrated in FIG. 4.

FIG. 4 shows an example of the social graph of the child with separate clusters 320 and 322. The contact nodes 302, 304, 308, 310 and 312 are included in the cluster of the natural group of friends 320 after analysis. Contact nodes 306 and 314 are included in the cluster of outliers 322. Different visualization methods may naturally be used, for example, colours and highlighting, in order to clearly present the outliers in the user interface.

In an embodiment, the user may be requested to choose whether he or she wishes to remove a certain contact node from the found outliers. It is possible that an outlier is accepted back to the natural group of friends, for example, when the parent has examined that this outlier is not harmful. There may be different options that can be chosen for controlling the possible outliers that are found.

In an embodiment, the found outliers may also be automatically removed from the contact nodes of the user. In an embodiment, when a new contact node is added, it may be detected whether or not the new contact node is an outlier, and the user may be warned not to add such a contact node to the list of contact nodes.

Without in any way limiting the scope, interpretation, or application of the claims appearing below, the technical effects of one or more of the example embodiments disclosed here reduce the security risks caused by potentially harmful contact nodes on end user devices. Resources of the system can also be saved when there is no need to browse through potentially hundreds of user profile information separately.

The steps, points, signaling messages and related functions described above in relation to FIG. 2 are in no absolute chronological order, and some of the steps may be performed simultaneously or in a different order. Other functions may also be executed between the steps or within the steps, and other signaling messages may be sent between the illustrated ones. Some of the steps can also be left out or replaced by a corresponding step. The system functions illustrate a procedure that may be implemented in one or more physical or logical entities.

The techniques described here may be implemented by various means. An apparatus or system that implements one or more of the described functions with an embodiment comprises not only existing means, but also means for implementing one or more functions of a corresponding apparatus that is described with an embodiment. An apparatus or system may also comprise separate means for each separate function. These techniques may be implemented in hardware (one or more modules) or combinations thereof. For software, implementation can be through modules, for example, procedures and functions that perform the functions described here. The software code may be stored in any suitable data storage medium that is readable by processors, computers, memory unit(s) or articles(s) of manufacture, and may be executed by one or more processors or computers. The data storage medium or memory unit may be implemented within the processor or computer, or as an external part of the processor or computer, in which case it can be connected to the processor or computer via various means known in the field.

The programming, such as executable code or instructions, electronic data, databases or other digital information can be stored into memories and may include a processor-usable medium. A processor-usable medium may be embodied in any computer program product or article of manufacture which can contain, store, or maintain programming, data or digital information for use by or in connection with an instruction execution system, including the processor 3 in the exemplary embodiment.

An embodiment provides a computer program product that comprises a computer-readable medium bearing computer program code embodied therein for use with a computer. The computer program code comprises code for retrieving from a social networking service at least one of: user profile information of a user and user profile information of each contact node of the user in the social networking service; and a connection structure between the user and each contact node of the user, code for analyzing the retrieved user profile information and/or the retrieved connection structure, and code for separating any outliers among the contact nodes on the basis of the analysis.

Embodiments of the present invention may be implemented in software, hardware, application logic or a combination of these. In an example of an embodiment, the application logic, software or a set of instructions is maintained on any conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The various aspects of the invention are not limited to the combinations explicitly set out in the independent claims. Other aspects of the invention may comprise combinations of features from the described embodiments, the dependent claims and the independent claims.

It is obvious to a person skilled in the field that, as the technology advances, the inventive concept can be implemented in various ways. The invention and its embodiments are not limited to the examples described above but may vary within the scope of the claims.

What is claimed is:

1. A method, comprising:
retrieving from a social networking service at least one of:
user profile information of a user and user profile information of each contact node of the user in the social networking service; and
a connection structure between the user and each contact node of the user,
analyzing the retrieved user profile information and/or the retrieved connection structure, and
separating any outliers among the contact nodes on the basis of the analysis.

2. The method of claim 1, wherein the user profile information comprises one or more of the following data elements but not limited to: age, gender, school, hometown, country, list of friends, relationship, work related, specific interests, religion, political opinion, hobbies, any available information from the user profile.

3. The method of claim 2, wherein analyzing the retrieved user profile information and/or the connection structure further comprises comparing one or more data elements of user profile information of the user and one or more corresponding data elements of user profile information of each contact node of the user.

4. The method of claim 1, further comprising: retrieving information from one or more data sources outside the social networking service; and using the retrieved information from one or more data sources outside the social networking service with the retrieved user profile information from the social networking service for separating the outliers.

5. The method of claim 1, wherein analyzing the retrieved user profile information and/or the connection structure further comprises using cluster analysis or corresponding detection techniques.

6. The method of claim 1, wherein retrieving the connection structure further comprises: retrieving information relating to connections and interconnections between different contact nodes of the user in the social networking service and between the user and each contact node of the user.

7. The method of claim 1, the method further comprising: predetermining one or more rules based on data elements of the user profile information and detecting whether required data elements of the user profile information of a contact node fulfill the predetermined one or more rules in order to separate the outliers.

8. The method of claim 1, the method further comprising: presenting the outlier separation results through a user interface.

9. The method of claim 8, wherein the separation results are presented in a graphical user interface in the form of a visual map of a cluster.

10. An apparatus, comprising:
at least one processor; and
at least one memory including executable instructions, the at least one memory and the executable instructions being configured to, in cooperation with the at least one processor, cause the apparatus to perform at least the following:
retrieve from a social networking service at least one of: user profile information of a user and user profile information of each contact node of the user in the social networking service; and a connection structure between the user and each contact node of the user,
analyze the retrieved user profile information and/or the retrieved connection structure, and
separate any outliers among the contact nodes on the basis of the analysis.

11. The apparatus of claim 10, wherein the user profile information comprises one or more of the following data elements but not limited to: age, gender, school, hometown, country, list of friends, relationship, work related, specific interests, religion, political opinion, hobbies, any available information from the user profile.

12. The apparatus of claim 11, wherein the apparatus is further conrigured to analyze the retrieved user profile information and/or the connection structure by comparing one or more data elements of user profile information of the user and one or more corresponding data elements of user profile information of each contact node of the user.

13. The apparatus of claim 10, wherein the apparatus is further configured to retrieve information from one or more data sources outside the social networking service; and to use the retrieved information from one or more data sources outside the social networking service with the retrieved user profile information from the social networking service for separating the outliers.

14. The apparatus of claim 10, wherein the apparatus is further configured to analyze the retrieved user profile information and/or the connection structure by using cluster analysis or corresponding detection techniques.

15. The apparatus of claim 10, wherein the apparatus is further configured to determine the connection structure by: retrieving information relating to connections and interconnections between different contact nodes of the user in the social networking service and between the user and each contact node of the user.

16. The apparatus of claim 10, wherein the apparatus is further configured to predetermine one or more rules based on data elements of the user profile information and to detect whether required data elements of the user profile information of a contact node fulfill the predetermined one or more rules in order to separate the outliers.

17. The apparatus of claim 10, wherein the apparatus is further configured to present the outlier separation results through a user interface.

18. The apparatus of claim 17, wherein the apparatus is further configured to present the separation results through a graphical user interface in the form of a visual map of a cluster.

19. A computer program comprising a computer-readable medium bearing computer program code embodied therein for use with a computer, the computer program code comprising:
code for retrieving from a social networking service at least one of: user profile information of a user and user profile information of each contact node of the user in the social networking service; and a connection structure between the user and each contact node of the user,
code for analyzing the retrieved user profile information and/or the retrieved connection structure; and
code for separating any outliers among the contact nodes on the basis of the analysis.

20. The computer program according to claim 19, wherein the computer program is a computer program product comprising a computer-readable medium bearing computer program code embodied therein for use with a computer.

21. A computer-readable medium encoded with instructions that, when executed by a computer, perform:
retrieving from a social networking service at least one of: user profile information of a user and user profile information of each contact node of the user in the social networking service; and a connection structure between the user and each contact node of the user,
analyzing the retrieved user profile information and/or the retrieved connection structure, and
separating any outliers among the contact nodes on the basis of the analysis.

22. The computer-readable medium of claim 21, wherein the user profile information comprises one or more of the following data elements but not limited to: age, gender, school, hometown, country, list of friends, relationship, work related, specific interests, religion, political opinion, hobbies, any available information from the user profile.

23. The computer-readable medium of claim 21, further comprising analyzing the retrieved user profile information and/or the connection structure by comparing one or more data elements of user profile information of the user and one or more corresponding data elements of user profile information of each contact node of the user.

24. The computer-readable medium of claim 21, wherein the apparatus is further configured to retrieve information from one or more data sources outside the social networking service; and to use the retrieved information from one or more data sources outside the social networking service with the retrieved user profile information from the social networking service for separating the outliers.

25. The computer-readable medium of claim 21, further comprising analyzing the retrieved user profile information and/or the connection structure by using cluster analysis or corresponding detection techniques.

26. The computer-readable medium of claim 21, further comprising determining the connection structure by retrieving information relating to connections and interconnections between different contact nodes of the user in the social networking service and between the user and each contact node of the user.

27. The computer-readable medium of claim 21, further comprising:
predetermining one or more rules based on data elements of the user profile information and detecting whether required data elements of the user profile information of a contact node fulfill the predetermined one or more rules in order to separate the outliers.

28. The computer-readable medium of claim 21, further comprising:
presenting the outlier separation results through a graphical user interface in the form of a visual map of a cluster.
